(19) United States
(12) Patent Application Publication
(10) Pub. No.: US 2007/0036430 A1
(43) Pub. Date: Feb. 15, 2007

(54) Image processing apparatus, method, and program

(75) Inventors: Masaya Katsumata, Kanagawa (JP); Yasuhiro Komiya, Tokyo (JP); Toru Wada, Saitama (JP); Osamu Konno, Saitama (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 11/498,507

(22) Filed: Aug. 3, 2006

(30) Foreign Application Priority Data
Aug. 10, 2005 (JP) 2005-232447

(51) Int. Cl. G06K 9/00

(52) U.S. Cl. 382/162; 382/128

(57) ABSTRACT

The invention provides an image processing apparatus including a region specifying unit for specifying a measurement-object region from an image; a measurement-region defining unit for defining at least one measurement region in the specified measurement-object region; and a characteristic-sample selecting unit for respectively selecting, from a plurality of characteristic samples that are registered in advance, at least one characteristic sample that is close to each measurement region.

### BACKGROUND OF THE INVENTION

1. Field of the Invention

The present invention relates to image processing systems for performing processing for high-precision color reproduction of an object. In particular, the present invention relates to an image processing system which is suitable for colorimetry of teeth, skin, and so forth.

This application is based on Japanese Patent Application No. 2005-232447, the content of which is incorporated herein by reference.

2. Description of Related Art

In recent years, there has been increased interest in beauty and health. In the beauty industry, for example, whitening for reducing melanin pigment in the skin has become a fashionable means in the pursuit of beauty.

Skin-diagnosis camera systems which are designed to allow observation of magnified images of the skin on a monitor are used in conventional skin diagnosis; for example, they are used in dermatology, aesthetic salons, beauty counseling, and so on. In the case of dermatology, for example, by observing images of the grooves and bumps in the skin, features of the skin surface can be diagnosed and counseling can be given. One example of such a skin-diagnosis camera is the apparatus described in Japanese Unexamined Patent Application Publication No. HEI-8-149352.

In the field of dentistry, dental treatments such as ceramic crowns are another aspect of the pursuit of beauty. The procedure of applying ceramic crowns involves first preparing a crown (a prosthetic tooth crown made of ceramic) having a color that is close to the color of the patient's original tooth, and this crown is then overlaid on the patient's tooth. In ceramic crown treatment, preparation of the prosthetic crown is critical. Conventionally, crowns are prepared by the process described below.

First, selection of a sample (shade guide) is performed by a doctor (this procedure is referred to as a “shade take” below). This involves selecting the shade guide that is closest to the color of the patient's tooth by checking the patient's tooth against tooth-shaped shade guides that are made of ceramics of a plurality of different colors. Each shade guide is assigned an identification number (hereinafter referred to as “shade-guide number”); the shade take is performed by specifying this number.

Then, the doctor acquires an image of the surface of the patient's tooth. This image acquisition is performed using a digital camera or the like designed for dentistry. For example, a system that can accurately acquire images of tooth color by automatically controlling the image brightness according to the distance to the object being photographed is disclosed in Japanese Unexamined Patent Application Publication No. 2005-40201.

Upon completion of the procedure describe above, the doctor sends the shade-guide number determined in the shade take and the acquired image to a dental laboratory which makes crowns. Then, the crown is produced in the dental laboratory based on this information.

However, the shade take described above has a problem in that it is not entirely quantitative because it depends on the subjective judgment of the doctor. Also, the appearance of the shade guide and the patient's tooth color may differ depending on various factors, such as the environmental conditions, the illumination (for example, the illumination direction and color), the level of fatigue of the doctor, and so on. Therefore, it is very difficult to select the optimal shade guide, which places a burden on the doctor.

In addition, the present invention is not limited to the field of dentistry described above. There are many applications where a sample that is close to actual characteristics (for example, a spectrum) is selected from characteristic samples that are prepared in advance, and there is a demand for techniques that allow optimal samples to be easily selected.

### BRIEF SUMMARY OF THE INVENTION

An object of the present invention is to provide an image processing apparatus, an image processing method, and a program in which a sample that is close to a characteristic of a test object is automatically selected from characteristic samples that are prepared in advance and is provided to a user so that he or she may easily perform a comparison.

A first aspect of the present invention is an image processing apparatus comprising a region specifying unit for specifying a measurement-object region from an image; a measurement-region defining unit for defining at least one measurement region in the specified measurement-object region; and a characteristic-sample selecting unit for respectively selecting, from a plurality of characteristic samples that are registered in advance, at least one characteristic sample that is close to a characteristic of each measurement region.

During image acquisition, for example, a region other than a measurement object is sometimes acquired together with the measurement object. According to the configuration described above, because a region specifying unit is provided for specifying the measurement-object region from the image that includes such a plurality of types of information, it is possible to extract only the information about the measurement object from the acquired image. In addition, the measurement regions are defined in this measurement-object region, and at least one characteristic sample that is close to the color thereof is selected in each measurement region. Therefore, when the measurement-object region is large or when the characteristic (for example, the spectrum) of the measurement object changes, it is possible to select a suitable characteristic sample for each location.

In addition to, for example, human body parts such as teeth, skin, and so on, other examples of the measurement object for which selection of characteristic samples is required include interior furnishings such as curtains and carpets, leather goods such as bags and sofas, electronic components, and painted cars, walls, and so forth.

In the first aspect of the present invention, the region specifying unit preferably specifies the measurement-object region based on a specific spectrum of the measurement object. If the measurement object has a specific spectrum, by specifying the measurement-object region based on this specific spectrum, it is possible to simplify the computational processing involved, which allows the computational load to be alleviated and the processing time to be reduced.

In the first aspect of the present invention, the characteristic-sample selecting unit preferably calculates a difference between a spectrum of the measurement region and a spectrum of the characteristic sample and selects the characteristic sample from this difference. Because the characteristic sample that is close to the characteristic of the measurement region is selected on the basis of the difference between the spectra, it is possible to efficiently and accurately select a suitable characteristic sample.

In the first aspect of the present invention, by applying a spectral-responsivity-related weighting to a difference between a spectrum of the measurement region and a spectrum of the characteristic sample, the characteristic-sample selecting unit preferably calculates a spectrum-determining value related to the degree of closeness of the two spectra and selects the characteristic sample based on the spectrum-determining value. By applying such a weighting, it is possible to improve the selection accuracy.

A second aspect of the present invention is an image processing apparatus comprising a region specifying unit for specifying a region of a tooth, serving as a measurement-object region, from an oral-cavity image; a measurement-region defining unit for defining at least one measurement region in the specified the measurement-object region; and a sample selecting unit for respectively selecting, from a plurality of tooth samples that are registered in advance, at least one tooth sample that is close to a spectrum of each measurement region.

In addition to the tooth to be measured, teeth neighboring this tooth, gums, and so forth, are also included in the oral-cavity image. Nevertheless, because the region specifying unit is provided, it is possible to specify only the tooth region to be measured from the oral-cavity image. In addition, because the measurement regions are defined in this measurement-object region and at least one tooth sample that is close to the characteristic (for example, the spectrum) thereof is selected for each measurement region, if the measurement-object region is large of if the characteristic (for example, the spectrum) changes, it is still possible to select a suitable tooth sample at each location. For example, because the chroma of the central part and the peripheral part of the tooth are usually different, by specifying the central part and the peripheral part as the measurement regions, it is possible to select a suitable tooth sample for each region of the tooth.

In the second aspect of the invention, the region specifying unit preferably specifies the tooth region from the oral-cavity image based on a specific spectrum of the tooth. By specifying the tooth region from the oral-cavity image on the basis of the specific spectrum of the tooth, it is possible to more accurately specify the tooth region.

In the second aspect of the invention, the region specifying unit preferably specifies the tooth region from the oral-cavity image based on a wavelength-band characteristic value, which is determined by a plurality of wavelength-band signals, and the specific spectrum of the tooth. By specifying the tooth region from the oral-cavity image on the basis of the wavelength-band characteristic value determined by the signals of a plurality of wavelength bands and the specific spectrum of the tooth, it is possible to simplify the computational processing involved. This allows the computational load to be alleviated and the processing time to be reduced.

In the second aspect of the invention, the sample selecting unit preferably calculates differences between a spectrum of the measurement region and a spectrum of the tooth sample, and selects at least one tooth sample in order of decreasing difference. Because the tooth sample that is close to the color of the measurement region is selected on the basis of the difference between the spectra, it is possible to select a suitable tooth sample efficiently and accurately.

In the second aspect of the invention, by applying a spectral-responsivity-related weighting to a difference between a spectrum of the measurement region and a spectrum of the tooth sample, the sample selecting unit preferably calculates a spectrum-determining value which is related to a degree of closeness of the two spectra and selects the tooth sample based on the spectrum-determining value. By applying such a weighting, it is possible to improve the selection accuracy.

A third aspect of the present invention is an image processing method comprising a region specifying step of specifying a measurement-object region from an image; a measurement-region defining step of defining at least one measurement region in the specified measurement-object region; and a characteristic-sample selecting step of respectively selecting, from a plurality of characteristic samples that are registered in advance, at least one characteristic sample that is close to the characteristic of each measurement region.

A fourth aspect of the present invention is an image processing program for causing a computer to execute region specifying processing for specifying a measurement-object region from an image; measurement-region defining processing for defining at least one measurement region in the specified measurement-object region; and characteristic-sample selecting processing for respectively selecting, from a plurality of characteristic samples that are registered in advance, at least one characteristic sample that is close to a characteristic of each measurement region.

A fifth aspect of the present invention is an image processing system comprising an image-acquisition apparatus for acquiring an image of an object including a measurement-object; an image-processing apparatus for processing the image acquired by the image-acquisition apparatus; and a display device for displaying the image processed by the image processing apparatus. The image processing apparatus includes a region specifying unit for specifying the measurement-object region from the image acquired by the image-acquisition apparatus; a measurement-region defining unit for defining at least one measurement region in the specified measurement-object region; and a characteristic-sample selecting unit for respectively selecting, from a plurality of characteristic samples that are registered in advance, at least one characteristic sample that is close to a characteristic of each measurement region.

A sixth aspect of the present invention is a dental colorimetry system comprising an image-acquisition apparatus for acquiring an oral-cavity image; an image processing apparatus for processing the image acquired by the image-acquisition apparatus; and a display device for displaying the image processed by the image processing apparatus. The image processing apparatus includes a region specifying unit for specifying a region of a tooth, serving as a measurement-object region, from the oral-cavity image acquired by the image-acquisition apparatus, a measurement-region defining unit for defining at least one measurement region in the specified measurement-object region, and a sample selecting unit for respectively selecting, from a plurality of tooth samples that are registered in advance, at least one tooth sample that is close to a spectrum of each measurement region.

A seventh aspect of the present invention is an image processing apparatus comprising a sample selecting unit for selecting, from tooth samples that are registered in advance, at least one tooth sample that is close to a spectrum of a measurement object; and a display control unit for displaying a color image of the measurement object, a color image of the selected tooth sample, and identification information for specifying the tooth sample.

According to this configuration, at least one tooth sample that is close to the spectrum of the measurement object is automatically selected, and a color image and identification information of this tooth sample, as well as a color image of the measurement object, are displayed on the screen. Therefore, by checking the screen, the user can easily select the tooth sample.

In the seventh aspect of the present invention, the display control unit preferably displays color-difference information of the tooth sample with respect to the measurement object. According to this configuration, it is possible to provide the user with auxiliary information to help the user to select the tooth sample.

In the seventh aspect of the present invention, when a reference position is indicated on at least one of the color image of the measurement object and the color image of the tooth sample, the display control unit preferably displays a chroma distribution image on the basis of a chroma value at the reference position. According to this configuration, the chroma distribution image based on the chroma value at the reference position is displayed on the color image of the tooth sample or the measurement object. Therefore, it is possible to provide the user with information which is helpful in selecting the tooth sample. Accordingly, because the user can consider many types of information, he or she can select a more suitable tooth sample.

In the seventh aspect of the present invention, the display control unit preferably displays at least part of one or more color images of the measurement object and at least part of one or more color images of the tooth sample adjacent to each other. Because the color image of the measurement object and the color image of the tooth sample are displayed adjacent to each other, it is possible to compare their colors directly. Accordingly, it is possible to identify subtle differences between colors.

In the seventh aspect of the present invention, preferably, a boundary between said at least part of the color image of the measurement object and said at least part of the color image of the tooth sample can move. By designing the system such that the boundary line between the measurement object and the tooth sample can move, it is possible to freely change the display ratio of the measurement object and the tooth sample. Furthermore, it is possible to directly compare a color at a specific position of the measurement object with the tooth sample. Therefore, by moving the boundary line to a desired position, it is possible to easily determine the best position to compare and the color of the tooth sample.

An eighth aspect of the present invention is a display method comprising selecting, from tooth samples that are registered in advance, at least one tooth sample that is close to a spectrum of a measurement object; and displaying a color image of the measurement object, a color image of the selected tooth sample, and identification information for specifying the tooth sample.

A ninth aspect of the present invention is a display program for causing a computer to execute processing comprising selecting, from tooth samples that are registered in advance, at least one tooth sample that is close to a spectrum of a measurement object; and displaying a color image of the measurement object, a color image of the selected tooth sample, and identification information for specifying the tooth sample.

The present invention affords an advantage in that it is possible to automatically select a sample that is close to the characteristic (for example, the spectrum) of an object from characteristic samples (for example, samples of spectra and so forth) that are prepared in advance and to present it to the user so that he or she may easily perform a comparison.

### BRIEF DESCRIPTION OF THE SEVERAL VIEWS OF THE DRAWINGS

FIG. 1 is a block diagram showing, in outline, the configuration of an image-acquisition apparatus and a cradle according to a first embodiment of the present invention.

FIG. 2 is a graph showing the spectra of a light source illustrated in FIG. 1.

FIG. 3 is a graph for explaining signal correction.

FIG. 4 is a block diagram showing, in outline, the configuration of an image processing apparatus according to the first embodiment of the present invention.

FIG. 5 is a schematic diagram of the internal configuration of a spectrum-estimation computing unit illustrated in FIG. 4.

FIGS. 6A and 6B are graphs for explaining input gamma correction.

FIG. 7 is a diagram showing an example of a low-pass filter applied to an R signal and a B signal in a pixel-interpolation computation.

FIG. 8 is a diagram showing an example of a low-pass filter applied to a G signal in the pixel-interpolation computation.

FIG. 9 is a graph showing an example of a reflectance spectrum of a tooth (number of samples, n=2).

FIG. 10 is a graph showing an example of the reflectance spectrum of gums (number of samples, n=5).

FIG. 11 is a diagram for explaining a method of specifying a tooth region according to the first embodiment of the present invention.

FIG. 12 is a diagram showing an example of measurement regions defined in a measurement-region defining process.

FIG. 13 is a diagram showing an example of a display screen.

FIG. 14 is a diagram showing an example of a display screen.

FIG. 15 is an example of an image displayed in a comparison region R in FIG. 14, showing the display in a case where a number of divisions is set to 2.

FIG. 16 is an example of an image displayed in the comparison region R in FIG. 14, showing the display in a case where the number of divisions is set to 4.

FIG. 17 is an example of an image displayed in the comparison region R in FIG. 14, showing the display in a case where the number of divisions is set to 6.

FIG. 18 is an example of an image displayed in the comparison region R in FIG. 14, showing the display in a case where the number of divisions is set to 8.

FIG. 19 is an example of an image displayed in the comparison region R in FIG. 14, showing the display in a case where the number of divisions is set to 10.

FIG. 20 is a block diagram showing, in outline, the configuration of an image processing apparatus according to a second embodiment of the present invention.

FIG. 21 is a diagram for explaining shade-guide determination according to the second embodiment of the present invention.

### DETAILED DESCRIPTION OF THE INVENTION

Embodiments in the case where an image-processing system of the present invention is used in a dental colorimetry system will be described below with reference to the drawings.

### First Embodiment

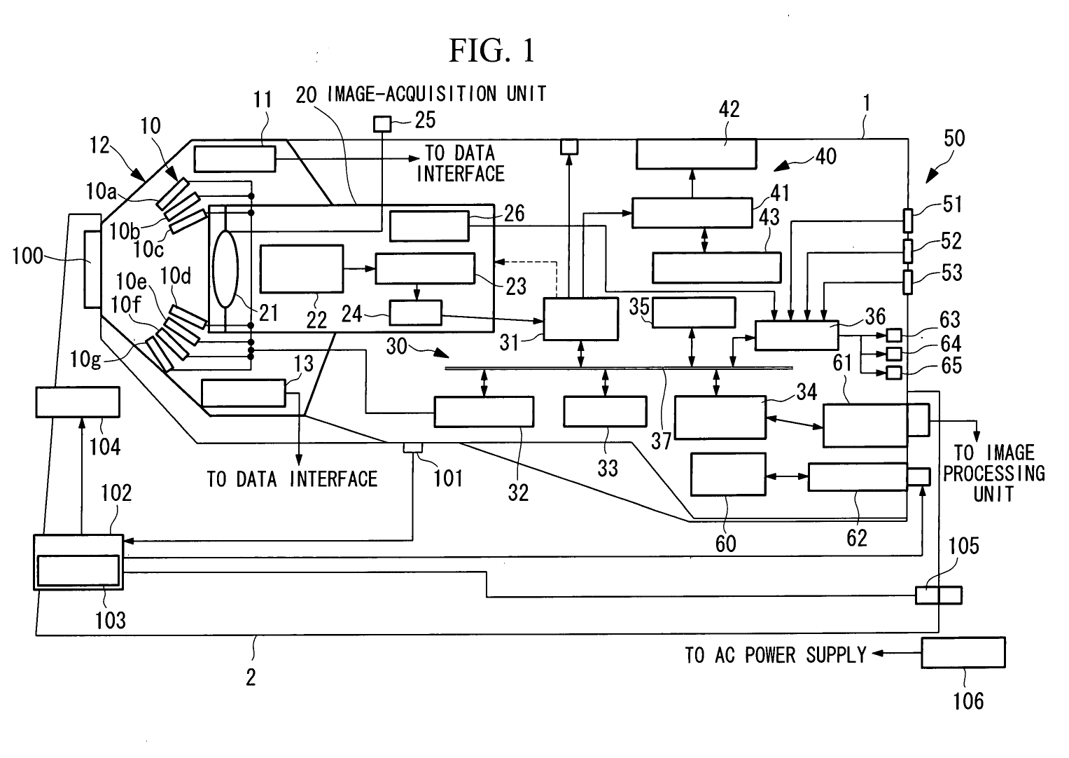

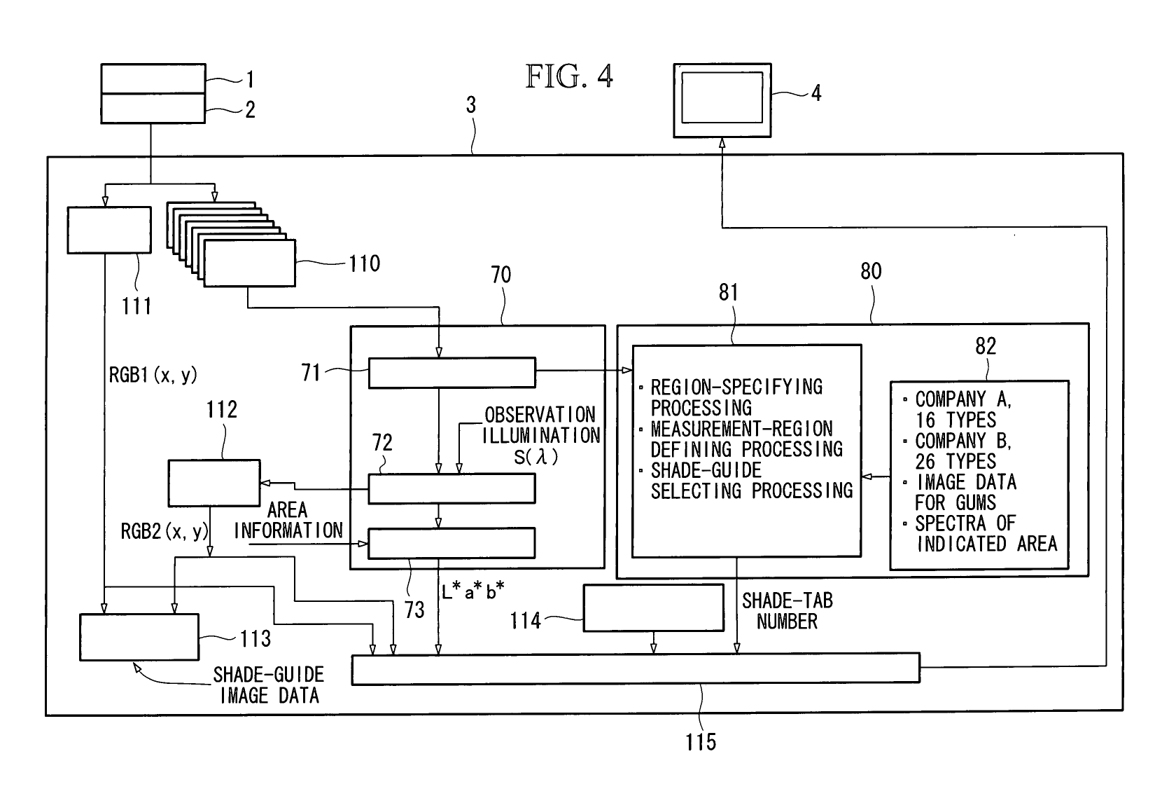

As shown in FIGS. 1 and 4, a dental colorimetry system according to this embodiment includes an image-acquisition apparatus 1, a cradle 2, an image processing apparatus 3, and a display device 4.

As shown in FIG. 1, the image-acquisition apparatus 1 includes a light source 10, an image-acquisition unit 20, an image-acquisition control unit 30, a display unit 40, and an operating unit 50 as the main constituent elements thereof.

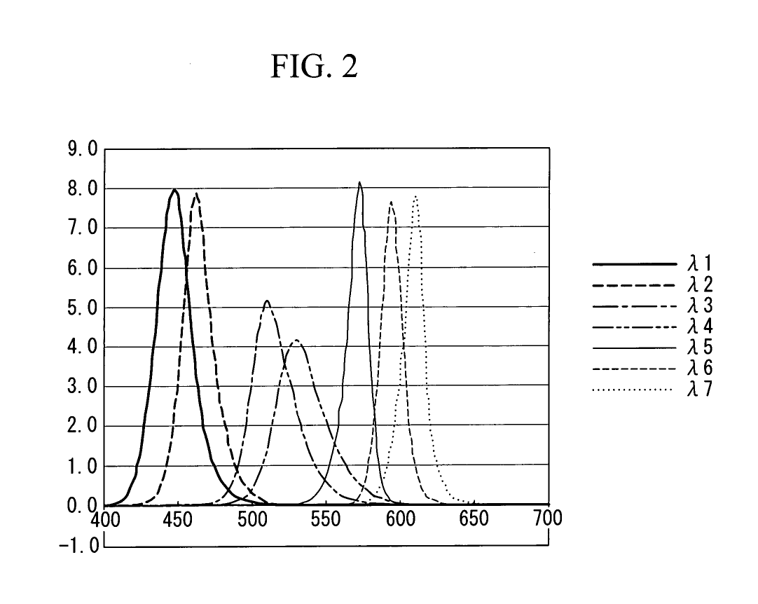

The light source 10 is disposed close to the tip of the image-acquisition apparatus 1 and emits illumination light for illuminating an object. The light source 10 is provided with seven light sources 10a to 10g which emit light in different wavelength bands. Each light source 10a to 10g includes four light emitting diodes (LEDs). As shown in FIG. 2, the central wavelengths thereof are as follows: the light source 10a, about 450 nm; the light source 10b, about 465 nm; the light source 10c, about 505 nm; the light source 10d, about 525 nm; the light source 10e, about 575 nm; the light source 10f, about 605 nm; and the light source 10g, about 630 nm. Emission-spectrum information about these LEDs is stored in an LED memory 11 and is used in the image processing apparatus 3, which is described later.

These light sources 10a to 10g are disposed, for example, in the form of a ring. Their arrangement is not particularly limited; for example, the four LEDs may be arranged in decreasing order of wavelength, in reverse order, or randomly. In addition to all of the LEDs being disposed so as to form a single ring, they may be disposed so that the LEDs are divided into a plurality of groups and each group forms one ring. The configuration of the LEDs is not limited to the ring shape described above; it is possible to employ any configuration, such as a cross-shaped arrangement, a rectangular arrangement, or a random arrangement, so long as they do not obstruct image acquisition by the image-acquisition unit 20, which is described later. The light emitting elements of the light source 10 are not limited to LEDs; for example, it is possible to use another type of light emitting element or a semiconductor laser such as a laser diode (LD).

In the image-acquisition apparatus 1, an illumination optical system for radiating the illumination light from the light source 10 substantially uniformly over the surface of the object is provided at the object side of the light source 10. A temperature sensor 13 for detecting the temperature of the LEDs is provided in the vicinity of the light source 10.

The image-acquisition unit 20 is formed of an image-pickup lens 21, an RGB color image-acquisition device 22, a signal processor 23, and an analog-to-digital (A/D) converter 24. The image-pickup lens 21 forms an image of the object illuminated by the light source 10. The RGB color image-acquisition device 22 acquires an image of the object which is imaged by the image-pickup lens 21 and outputs an image signal. The RGB color image-acquisition device 22 is formed, for example, of a CCD, and the sensor responsivity thereof substantially covers a wide visible region of the spectrum. The CCD may be a monochrome or color device. The RGB color image-acquisition device 22 is not limited to a CCD; it is possible to use other types of devices, such as CMOS image sensors.

The signal processor 23 subjects the analog signal output from the RGB image-acquisition device 22 to gain correction, offset correction, and so on. The A/D converter 24 converts the analog signal output from the signal processor 23 into a digital signal. A focus lever 25 for adjusting the focus is connected to the image-pickup lens 21. This focus lever 25 is used to manually adjust the focus, and a position detector 26 for detecting the position of the focus lever 25 is provided.

The image-acquisition control unit 30 is formed of a CPU 31, an LED driver 32, a data interface 33, a communication interface controller 34, an image memory 35, and an operating-unit interface 36. These components are each connected to a local bus 37 and are configured to enable transmission and reception of data via the local bus 37.

The CPU 31 controls the image-acquisition unit 20, records a spectral image of the object acquired and processed by the image-acquisition unit 20 in the image memory 35 via the local bus 37, and outputs the image to an LCD controller 41, which is described later. The LED driver 32 controls the light emission of each LED provided in the light source 10. The data interface 33 receives the contents of the LED memory 11 and information from the temperature sensor 13, which are provided at the light source 10. The communication interface controller 34 is connected to a communication-interface contact point 61, which is used for external connection, and has a function for performing communication via a USB 2.0 connection, for example. The operating-unit interface 36 is connected to various operating buttons provided on the operating unit 50, which is described later, and functions as an interface for forwarding instructions input via the operating unit 50 to the CPU 31 via the local bus 37. The image memory 35 temporarily stores image data acquired in the image-acquisition unit 20. In this embodiment, the image memory 35 has sufficient capacity for storing at least seven spectral images and one RGB color image.

The display unit 40 is formed of the LCD controller 41 and a liquid crystal display (LCD) 42. The LCD controller 41 displays on the LCD 42 an image based on the image signal sent from the CPU 31, for example, the image currently being acquired by the image-acquisition unit 20 or a previously acquired image. As required, an image pattern stored in an overlay memory 43 may be superimposed on the image obtained from the CPU 31 and displayed on the LCD 42. The image pattern stored in the overlay memory 43 is, for example, a horizontal line for acquiring an image of the entire tooth horizontally, a cross line perpendicular thereto, an image-acquisition mode, an identification number of the acquired tooth, and so forth.

The operating unit 50 is provided with various operating switches and operating buttons for the user to input an instruction to commence spectral image acquisition and an instruction to commence or terminate moving-image acquisition. More specifically, the operating unit 50 includes an image-acquisition-mode switch 51, a shutter button 52, a viewer control button 53, and so forth. The image-acquisition-mode switch 51 is for switching between standard RGB image-acquisition and multispectral image acquisition. The viewer control button 53 is a switch for changing the image displayed on the LCD 42.

The image-acquisition apparatus 1 has a built-in lithium battery 60. This lithium battery 60, which supplies electrical power to each component of the image-acquisition apparatus 1, is connected to a connection point 62 for charging. A battery LED 63 for indicating the charging status of this lithium battery is provided. In addition, a power LED 64 for indicating the status of the camera and an alarm buzzer 65 for indicating a warning during image acquisition are also provided in the image-acquisition apparatus 1.

The battery LED 63 is provided with three LEDs, for example, red, yellow, and green LEDs. The battery LED 63 indicates that the lithium battery 60 is sufficiently charged by glowing green; that the battery charge is low by glowing yellow, in other words, that charging is required; and that the battery charge is extremely low by glowing red, in other words, that charging is urgently required.

The power LED 64 is provided with two LEDs, for example red and green LEDs. The power LED indicates that image-acquisition preparation has been completed by glowing green, that image-acquisition preparation is currently underway (initial warm-up and so on) by flashing green, and that the battery is currently being charged by glowing red.

The alarm buzzer 65 indicates that the acquired image data is invalid by issuing an alarm sound.

The cradle 2 supporting the image-acquisition apparatus 1 includes a color chart 100 for calibrating the image-acquisition unit 20; a microswitch 101 for determining whether or not the image-acquisition apparatus 1 is installed in the correct position; a power switch 102 for turning the power supply on and off; a power lamp 103 which turns on and off in conjunction with the on and off states of the power switch 102; and an installed lamp 104 for indicating whether or not the image-acquisition apparatus 1 is installed in the correct position.

The installed lamp 104 glows green when, for example, the image-acquisition apparatus 1 is installed in the correct position and glows red when it is not installed. A power connector 105 is provided on the cradle 2, and an AC adaptor 106 is connected thereto. When the charge of the lithium battery 60 provided in the image-acquisition apparatus 1 is reduced and the battery LED glows yellow or red, the cradle 2 is designed such that charging of the lithium battery starts when the image-acquisition apparatus 1 is placed in the cradle 2.

The image-acquisition apparatus 1 of the dental colorimetry apparatus having such a configuration can perform both multispectral image acquisition and RGB image acquisition. In multispectral image acquisition, illumination light beams of seven wavelength bands (illumination light beams of seven colors) are sequentially radiated onto the object and seven spectral images of the object are acquired as still images. One RGB image-acquisition method is a method in which image acquisition of an object illuminated with natural light or room light, rather than illumination light of seven colors, is carried out using an RGB color CCD provided in the apparatus, just like a standard digital camera. By selecting one or more illumination beams from the illumination beams of seven colors as three RGB illumination beams and radiating them sequentially, it is also possible to acquire frame-sequential still images.

Among these image-acquisition modes, the RGB mode is used when acquiring an image of a large area, such as when acquiring a full-face image of a patient, a full-jaw image, and so on. On the other hand, multispectral image acquisition is used when accurately measuring the color of one or two of the patient's teeth, in other words, when performing colorimetry of the teeth.

Colorimetry processing of a tooth using multispectral image acquisition, which is the main subject matter of the present invention, will be described below.

Multispectral Image Acquisition

First, the image-acquisition apparatus is lifted from the cradle 2 by a doctor, and a contact cap is attached to a mounting hole (not shown in the drawings) provided at the side of the image-acquisition apparatus case from which light is emitted. This contact cap is made of a flexible material and has a substantially cylindrical shape.

Then, the image-acquisition mode is set to “colorimetry mode” by the doctor, whereupon the object is displayed as a moving image on the LCD 42. While looking at the image displayed on the LCD 42, the doctor positions the apparatus so that the natural tooth of the patient, which is the object to be measured, is disposed at a suitable position in the image-acquisition area and adjusts the focus using the focus lever 25. The contact cap is formed in a shape which guides the tooth to be measured to a suitable image-acquisition position, and therefore, it is possible to easily carry out this positioning.

Once positioning and focus adjustment have been completed, the doctor presses the shutter button 52, whereupon a signal to that effect is sent to the CPU 31 via the operating unit interface 36, and multispectral image-acquisition is executed under the control of the CPU 31.

In multispectral image acquisition, by sequentially driving the light sources 10a to 10g with the LED driver 32, LED radiation light of different wavelength bands is sequentially radiated onto the object. The reflected light from the object forms an image on the surface of the RGB image-acquisition device 22 in the image-acquisition unit 20, and is acquired as an RGB image. The acquired RGB image is sent to the signal processor 23. The signal processor 23 subjects the input RGB image signal to predetermined image processing and, from the RGB image signal, selects image data of one predetermined color in response to the wavelength bands of the light sources 10a to 10g. More specifically, the signal processor 23 selects the B image data from the image signal corresponding to the light sources 10a and 10b, selects the G image data from the image signal corresponding to the light sources 10c to 10e, and selects the R image data from the image signal corresponding to the light sources 10f and 10g. Therefore, the image processing unit 23 selects image data of wavelengths which substantially match the central wavelengths of the illumination light.

The image data selected by the signal processor 23 is sent to the A/D converter 24 and is stored in the image memory 35 via the CPU 31. As a result, the color images selected from the RGB images corresponding to the central wavelengths of the LED are stored in the image memory 35 as multispectral images. During image acquisition, the LED radiation time and radiation intensity, the electronic shutter speed of the image-acquisition device 1, and so forth are controlled by the CPU 31 so that image acquisition of the respective wavelengths is performed with the proper exposure; if there is a severe temperature change during image acquisition, the alarm buzzer 65 emits an audible alarm.

Another image of the natural tooth is acquired without illuminating the LEDs and is stored in the image memory 35 as an external-light image.

Next, once image acquisition has been completed and the image-acquisition apparatus 1 is placed in the cradle 2 by the doctor, calibration image measurement performed.

The calibration image measurement is for acquiring an image of the color chart 100 using the same procedure as that used for the multispectral image acquisition described above. Accordingly, a multispectral image of the color chart 100 is stored in the image memory 35 as a color-chart image.

Next, image acquisition of the color chart 100 is carried out without illuminating any of the LEDs (under darkness), and this image is stored in the image memory 35 as a dark-current image. This dark-current image may be formed by performing image acquisition a plurality of times and averaging the images obtained.

Next, signal correction using the above-described external-light image and dark-current image stored in the image memory 35 is performed for the multispectral image and the color-chart image, respectively. The signal correction for the multispectral image is performed, for example, by subtracting a signal value of the external-light image data at each pixel from the image data of the multispectral image, which allows the effect of external light during image acquisition to be eliminated. Similarly, the signal correction for the color-chart image is carried out, for example, by subtracting a signal value of the dark-current image data at each pixel from the image data of the color-chart image, which allows dark-current noise removal of the CCD, which changes depending on temperature, to be performed.

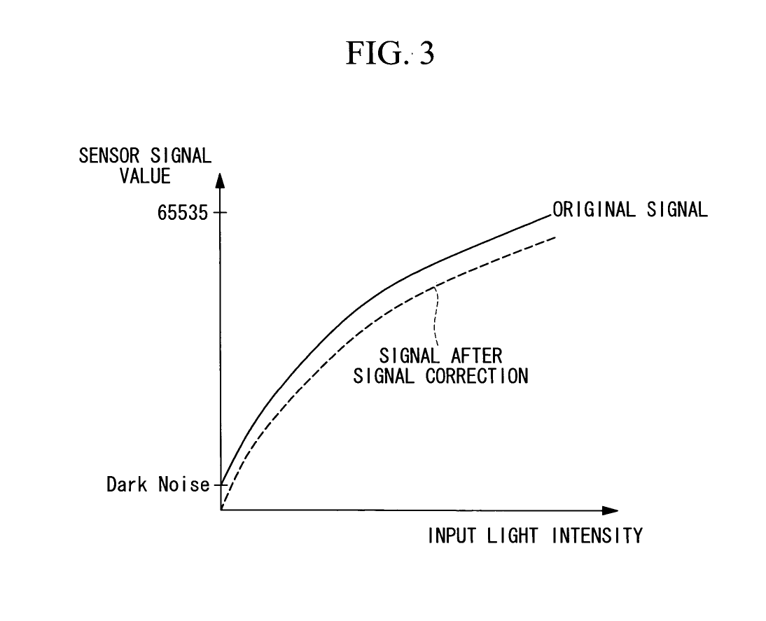

FIG. 3 shows an example of the signal correction results for the color-chart image. In FIG. 3, the vertical axis indicates the sensor signal value and the horizontal axis indicates the input light intensity. The solid line shows the original signal before correction and the dotted line shows the signal after correction.

After signal correction, the multispectral image and the color-chart image are sent to the image processing apparatus 3 via the local bus 37, the communication interface controller 34, and the communication interface connection point 61 and are stored in a multispectral image memory 110 in the image processing apparatus 3, as shown in FIG. 4.

The system may also be configured such that the multispectral image and dark-current image of the above-described color chart 100 are sent directly to the image processing apparatus 3 via the local bus 37, the communication interface controller 34, and the communication interface connection point 61, without being stored in the image memory 35 in the image-acquisition apparatus 1, and are stored in the multispectral image memory 110 in the image processing apparatus 3. In such a case, the signal correction described above is carried out in the image processing apparatus 3.

The image processing apparatus 3, which is formed, for example, of a personal computer, receives the multispectral image and the color-chart image output via the communication interface connection point 61 in the image-acquisition apparatus 1, and subjects the multispectral image to various types of processing. By doing so, it forms an image of the tooth (the object) which has a high degree of color reproducibility, selects an appropriate shade-guide number for the tooth, and displays this information on the display device 4.

As shown in FIG. 4, for example, the image processing apparatus 3 is formed of a chroma calculating unit 70, a shade-guide-number determining unit 80, the multispectral image memory 110, an RGB image memory 111, a color-image-generating processor 112, an image filing unit 113, a shade-guide chroma-data storage unit 114, and an image-display GUI unit (display control unit) 115.

The chroma calculating unit 70 is formed of a spectrum-estimation computing unit 71, an observation-spectrum computing unit 72, and a chroma-value computing unit 73. The shade-guide-number determining unit 80 includes a determination computing unit 81 and a shade-guide reference-image-data storage unit 82. This shade-guide reference-image-data storage unit 82 stores, for example, shade-guide image data, in association with shade guide numbers, for each manufacturer producing shade guides in which color samples are arranged in rows; in addition, it also stores spectral reflectance curves for predetermined areas of these shade guides and shade guide images associated with the gums.

In the image processing apparatus 3 having such a configuration, the multispectral image and color-chart image sent from the image-acquisition apparatus 1 are first stored in the multispectral-image memory 110, and thereafter are sent to the chroma calculating unit 70. In the chroma calculating unit 70, first, spectrum (in this embodiment, a spectral reflectance curve) estimation processing and so forth are carried out by the spectrum-estimation computing unit 71.

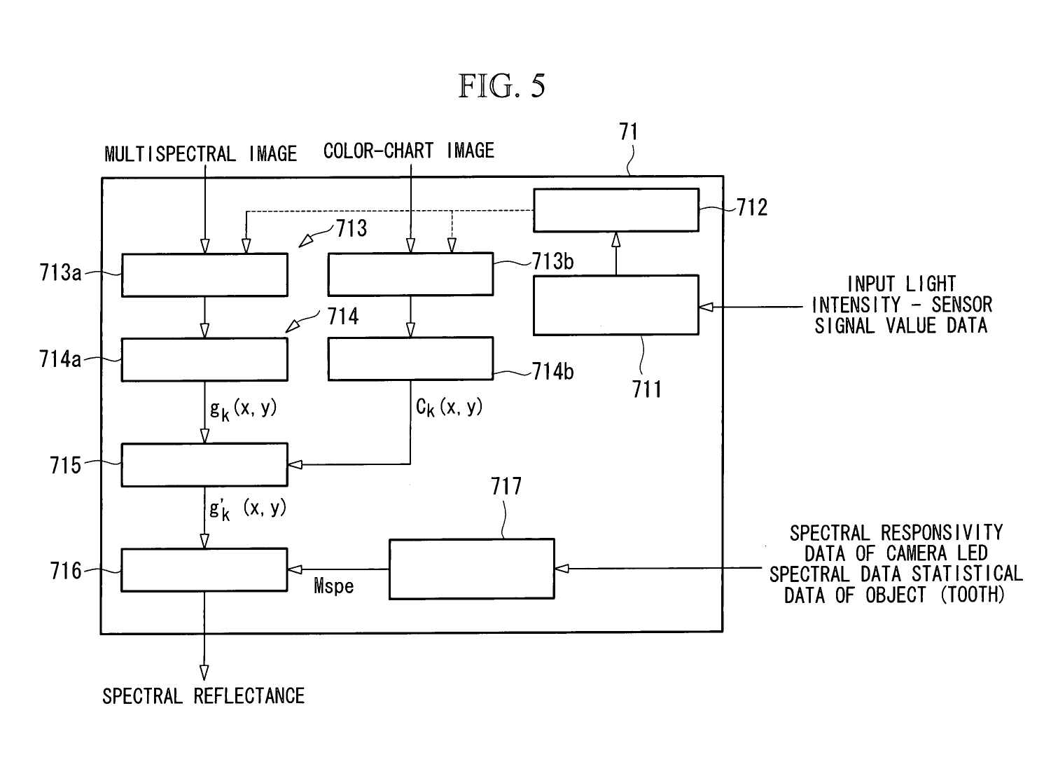

As shown in FIG. 5, the spectrum-estimation computing unit 71 is formed of a conversion-table generator 711, a conversion table 712, an input-gamma correction unit 713, a pixel-interpolation unit 714, an intraimage nonuniformity correction unit 715, a matrix computing unit 716, and a spectrum-estimation matrix generator 717. Separate input-gamma correction units 713 and pixel-interpolation units 714 are provided for the multispectral image and the color-chart image, respectively; that is, an input-gamma correction unit 713a and a pixel-interpolation unit 714a are provided for the multispectral image, and an input-gamma correction unit 713b and a pixel-interpolation unit 714b are provided for the color-chart image.

In the spectrum-estimation computing unit 71 having such a configuration, first the multispectral image and the color-chart image are sent to the separate input-gamma correction units 713a and 713b, respectively, and after input-gamma correction is performed, they are subjected to pixel-interpolation processing by the corresponding pixel-interpolation units 714a and 714b. The signals obtained after this processing are sent to the intraimage nonuniformity correction unit 715, where intraimage nonuniformity correction processing is performed on the multispectral image using the color-chart image. Thereafter, the multispectral image is sent to the matrix computing unit 716, and the spectral reflectance is calculated using a matrix generated by the spectrum-estimation matrix generator 717.

The image processing carried out in each unit will be described more concretely below.

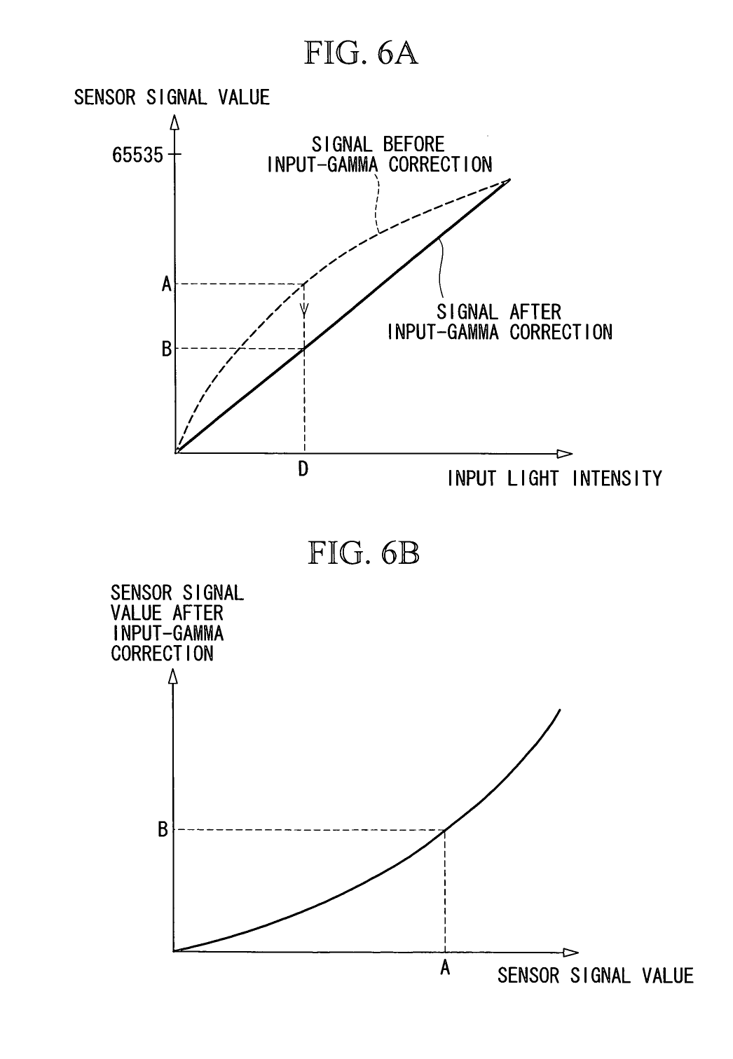

First, prior to input-gamma correction, the conversion table 712 is created by the conversion-table generator 711. More specifically, the conversion-table generator 711 contains data associating the input light intensity and the sensor signal value, and it creates the conversion table 712 based on this data. The conversion table 712 is created from the relationship between the input light intensity and the output signal value; as shown by the solid line in FIG. 6A for example, it is created such that the input light intensity and the sensor signal value are substantially linearly proportional.

The input-gamma correction units 713a and 713b perform input-gamma correction on the multispectral image and the color-chart image, respectively, by referring to this conversion table 712. This conversion table 712 is created such that an input light intensity D corresponding to a current sensor value A is obtained and an output sensor value B corresponding to this input light intensity D is output; the result is shown in FIG. 6B. Accordingly, when input-gamma correction is performed on the multispectral image and the color-chart image, the corrected image data is sent to the pixel-interpolation units 714a and 714b, respectively.

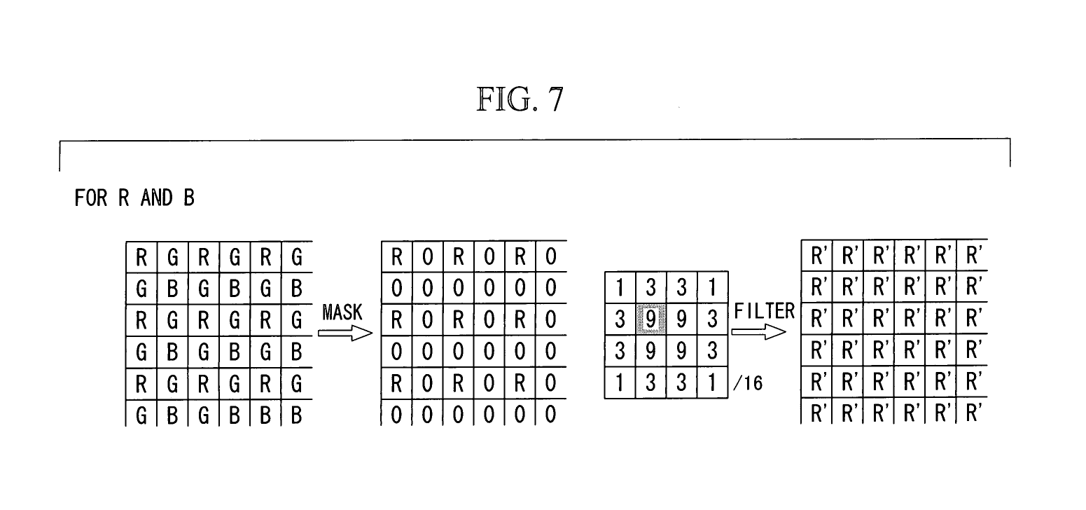

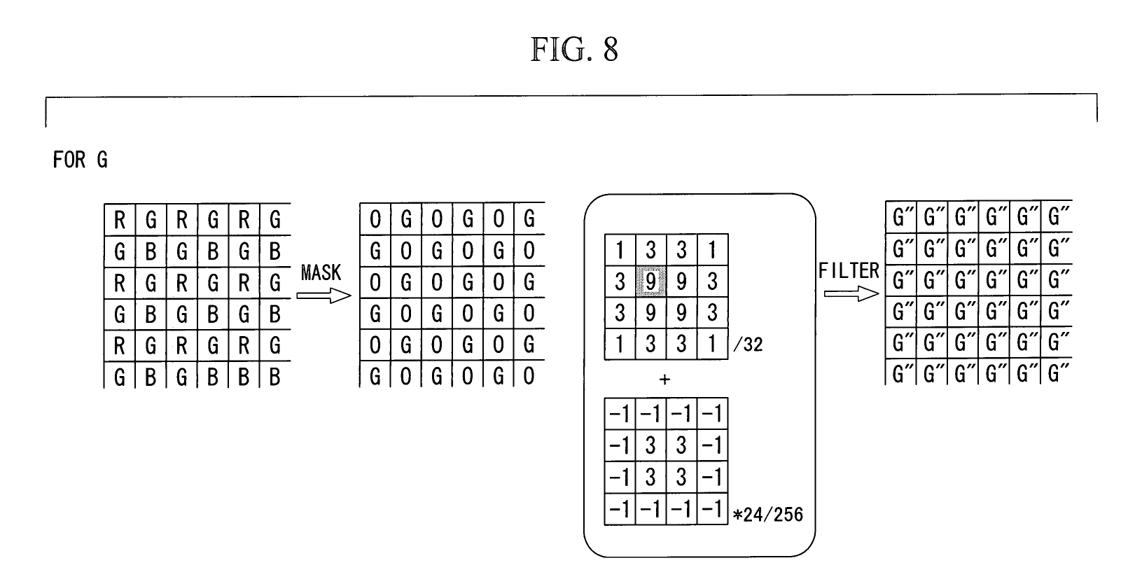

In the pixel-interpolation units 714a and 714b, pixel interpolation is performed by multiplying each of the multispectral image data and the color-chart image data, which have been subjected to input-gamma correction, by a low-pass filter for pixel interpolation. FIG. 7 shows an example of a low-pass filter applied to the R signal and the B signal. FIG. 8 shows a low-pass filter applied to the G signal. By multiplying each multispectral image data value by such low-pass filters for pixel interpolation, a 144×144 pixel image, for example, becomes a 288×288 pixel image.

Image data gk(x,y) which has been subjected to pixel interpolation is then sent to the intraimage nonuniformity correction unit 715.

The intraimage nonuniformity correction unit 715 corrects the luminance at the center of the screen of the multispectral image data using equation (1) below.

$${g}_{k}^{′} ( x , y ) = {g}_{k} ( x , y ) \frac{{\sum }_{η = {y}_{0} - δ / 2}^{{y}_{0} + δ / 2} {\sum }_{ξ = {x}_{0} - δ / 2}^{{x}_{0} + δ / 2} {c}_{k} ( ξ , η ) / {δ}^{2}}{{\sum }_{η = y - δ / 2}^{y + δ / 2} {\sum }_{ξ = x - δ / 2}^{x + δ / 2} {c}_{k} ( ξ , η ) / {δ}^{2}} \qquad ( 1 )$$

In equation (1), ck(x,y) is acquired image data of the color chart, gk(x,y) is the multispectral image data after input-gamma correction, (x0,y0) is the center pixel position, δ (=5) is the area averaging size, and g′k(x,y) is the image data after intraimage nonuniformity correction (where k=1, . . . , N (the number of wavelength bands)).

The intraimage nonuniformity correction described above is performed on each data value of the multispectral image data.

The multispectral image data after intraimage nonuniformity correction, g′k(x,y), is sent to the matrix computing unit 716. The matrix computing unit 716 performs spectrum (spectral reflectance) estimation processing using the multispectral image data g′k(x,y) from the intraimage nonuniformity correction unit 715. In this spectrum (spectral reflectance) estimation processing, in the wavelength band from 380 nm to 780 nm, estimation of the spectral reflectance is performed in 1-nm intervals. That is, in this embodiment, 401-dimension spectral reflectance data is estimated.

Generally, in order to obtain spectral reflectances for each single wavelength, large, expensive spectrometers or the like are used. In this embodiment, however, because the subjects are limited to teeth, by using predetermined characteristics of those objects, the 401-dimensional spectral reflectance data can be estimated with a small number of bands.

More specifically, the 401-dimensional spectral signal is calculated by performing a matrix calculation using the multispectral image data g′k(x,y) and a spectrum-estimation matrix Mspe.

The spectrum-estimation matrix Mspe described above is created in the spectrum-estimation matrix generator 717 based on spectral responsivity data of the camera, spectral data of the LEDs, and statistical data of the object (tooth). The creation of this spectrum-estimation matrix is not particularly limited; known methods in the literature may be used. One example is described in S. K. Park and F. O. Huck, “Estimation of spectral reflectance curves from multispectrum image data”, Applied Optics, Vol. 16, pp. 3107-3114 (1977).

The spectral responsivity data of the camera, the spectral data of the LEDs, the statistical data of the object (tooth), and so on are stored in advance in the image filing unit 113 shown in FIG. 4. If the spectral responsivity of the camera changes depending on the sensor position, position-dependent spectral responsivity data may be obtained, or appropriate correction may be performed on the data for the central position.

When the spectral reflectance is computed by the spectrum-estimation computing unit 71, the computation result is sent, together with the multispectral image data, to the shade-guide-number determining unit 80 and the observation-spectrum computing unit 72 in and the chroma calculating unit 70, as shown in FIG. 4.

Information from the spectrum-estimation computing unit 71 is sent to the determination computing unit 81 in the shade-guide-number determining unit 80. In the determination computing unit 81, first, region-specifying processing for specifying a tooth region to be measured is carried out.

Here, information about the tooth to be measured, as well as information about the neighboring teeth, the gum, and so forth, is also included in the multispectral image data acquired by the image-acquisition apparatus 1. Therefore, processing for specifying the tooth region to be measured from this oral-cavity image data is carried out in the region-specifying processing.

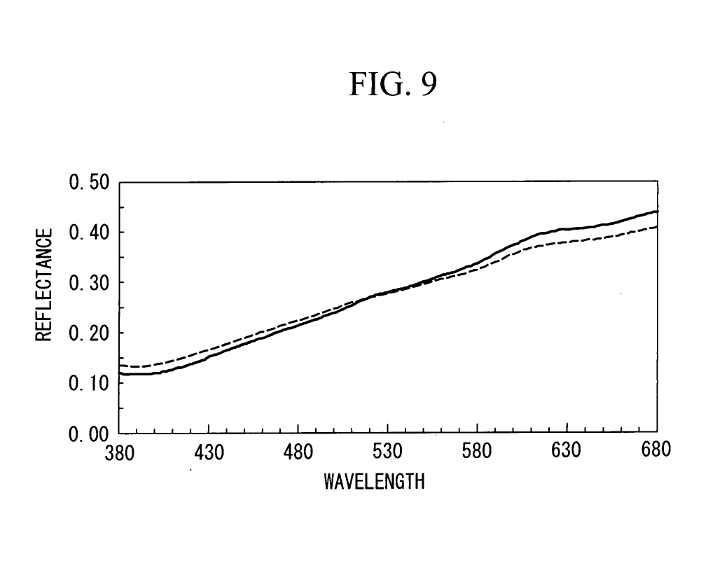

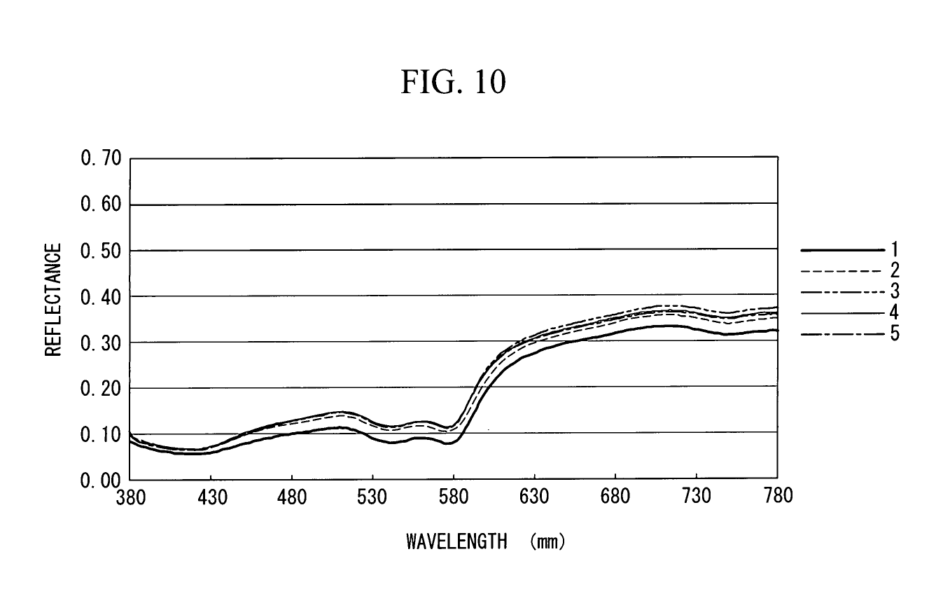

An example of the reflectance spectrum of the tooth (number of samples, n=2) is shown in FIG. 9, and an example of the reflectance spectrum of the gum (number of samples, n=5) is shown in FIG. 10. In FIGS. 9 and 10, the horizontal axis indicates wavelength and the vertical axis indicates reflectance. Because the tooth is completely white and the gum is red, there is a large difference between the two spectra in the blue wavelength band (for example, from 400 nm to 450 nm) and in the green wavelength band (for example, from 530 nm to 580 nm), as is clear from FIGS. 9 and 10. Thus, in this embodiment, noting that the tooth has a specific reflectance spectrum, the tooth region is specified by extracting from the image data pixels exhibiting this specific tooth reflectance spectrum.

Tooth-Region (Measurement-Object Region) Specifying Method 1

In this method, in a region in the image represented by the acquired multispectral image data (a pixel or a group of pixels), wavelength-band characteristic values determined by respective signal values of n wavelength bands form an n-dimensional space. Thus, in this dimensional space, a plane representing the characteristic of the measured object is defined. When the wavelength-band characteristic values represented in the n-dimensional space are projected onto this plane, the region (outline) to be measured is specified by determining that the region in the image having that wavelength-band characteristic value is included in the tooth region to be measured.

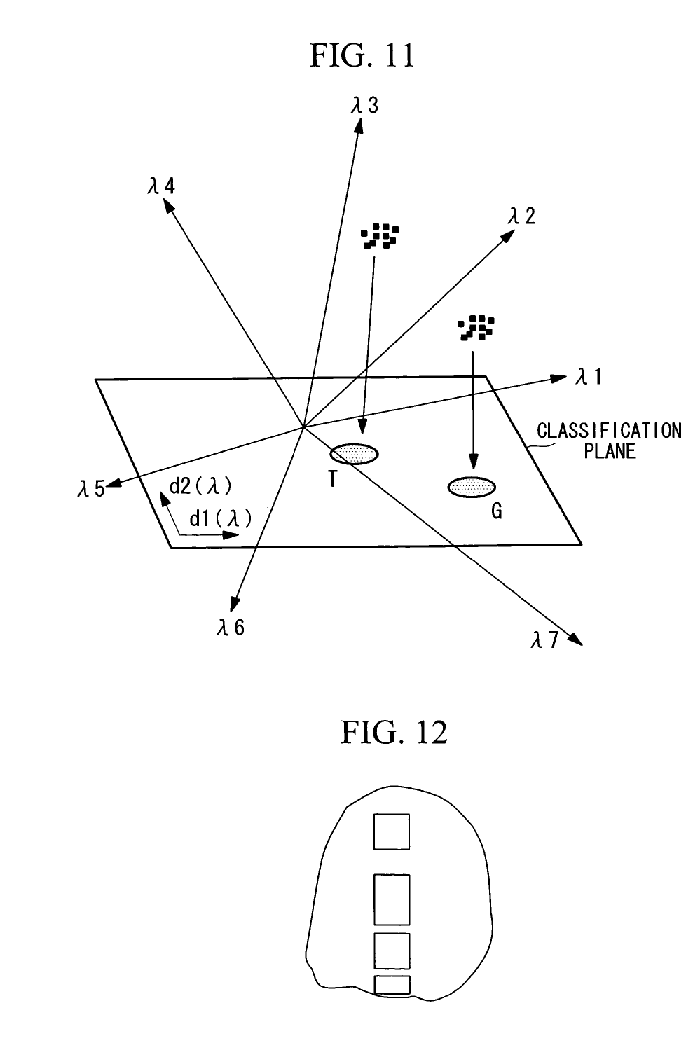

FIG. 11 illustrates the method for specifying the tooth region to be measured using this method. As shown in FIG. 11, a 7-dimensional space is formed by seven wavelengths λ1 to λ7. A classification plane for optimally separating the tooth to be measured is defined in the 7-dimensional space. More specifically, classification spectra d1(λ) and d2(λ) for plane projection are determined. Then, a predetermined region is first cut out from the acquired multispectral image data, and a feature value which is represented in the 7-dimensional space is computed as the wavelength-band characteristic value. The feature value is a combination of seven signal values obtained when each band in the cut-out region is averaged in this region and converted to seven signal values. The size of the cut-out region is, for example 2 pixels×2 pixels, but it is not limited to this size; it may be 1 pixel×1 pixel, or it may be 3 pixels×3 pixels or larger.

The feature value is represented by a single point in the 7-dimensional space in FIG. 11. The single point in the 7-dimensional space represented by this feature value is projected onto the classification plane to obtain one point on the classification plane. The coordinates of the point on the classification plane can be obtained from the inner product of the classification spectra d1(λ) and d2(λ). If the point on the classification plane is included in a region T on the classification plane, determined by the characteristic spectrum of the tooth, that is, in a planar region representing the characteristics of the measured object, the cut-out region is determined to be included within the outline of the tooth. On the other hand, if the point on the classification plane is included in a region G, determined by the characteristic spectrum of the gum, the cut-out region is determined to be included within the outline of the gum.

In this method, the tooth region is specified by sequentially carrying out this determination while changing the cut-out region. In particular, the tooth region to be measured is normally positioned close to the center of the image represented by the acquired multispectral image data. Therefore, the tooth region to be measured (in other words, the outline of the tooth to be measured) is specified by sequentially carrying out the above-described determination of whether or not the cut-out region is included in the tooth region while moving the cut-out region from the vicinity of the center of the image towards the periphery. In particular, this embodiment is advantageous in that it is possible more accurately specify the region (outline) to be measured, because the feature value is defined in a 7-dimensional space, which has more dimensions than a 3-dimensional space formed by the standard RGB image.

Tooth-Region (Measurement-Object Region) Specifying Method 2

In addition to the region specifying method based on the classification spectrum described above, this method specifies as the tooth region a region having a signal value (spectrum) that is unique to the tooth. This is achieved by extracting, for example, only signal values (spectra) corresponding to the blue wavelength band and the green wavelength band and comparing these signal values. According to this method, because the number of samples to compare is low, it is possible to easily carry out region specifying in a short period of time.

More concretely, similar to the case described above where region specifying is carried out based on the classification spectrum, by detecting the position of an inflection point where the spectral feature value changes suddenly, that position is determined to be the outline of the tooth to be measured. For example, an object to be detected (tooth) and an object to be separated (an object other than the tooth, such as the gum) are compared, characteristic bands λ1 and λ2 are selected, and the ratio thereof yields the spectral feature value. When the object to be detected is a tooth, the ratio of two points is calculated as, for example, λ1=450 nm and λ2=550 nm to obtain the inflexion point of that ratio. Accordingly, it is possible to determine the boundary with the neighboring tooth and to obtain pixels of the tooth to be measured. In addition to performing specifying for each pixel, it is also possible to take the average of pixel groups formed of a plurality of pixels and to perform specifying for each pixel group based on this average.

Whichever of the tooth-region specifying methods 1 and 2 described above is used, in this embodiment, region specification is carried out for the tooth. However, it is also possible to carry out region specification for the gum. Apart from teeth, it can also be used in other applications, for example, region specification of blemishes, freckles, and so forth on the skin, region specification of a predetermined paint color within a multicolor painted pattern, and so on. In these cases, a specific spectrum of the region to be specified, such as the gum, blemish, freckle, paint etc., may be used. For example, when performing region specification of a blemish or freckle, a specific spectrum of a benign blemish or freckle and a specific spectrum of a malignant blemish or freckle are stored in advance, and by specifying regions close to these spectra, it is possible to easily perform region specification of the measurement object.

Accordingly, once the pixels of the tooth to be measured are specified, next, measurement-region defining processing is carried out for defining measurement regions in the tooth region to be measured. As shown in FIG. 12, these measurement regions are defined as rectangular regions at the top, middle, and bottom of the tooth surface. For example, regions having areas with fixed ratios with respect to their height on the tooth are defined. In other words, whether the tooth is large or small, the measurement regions and the positions thereof are defined with a constant ratio. The shapes of the measurement regions are not limited to the rectangular shapes shown in FIG. 12; for example, the shapes may be circular, elliptical, or asymmetric.

Next, shade-guide selecting processing (sample selecting processing) for selecting the closest shade guide is carried out for each measurement region defined as described above. In this shade-guide selecting processing, the color of the tooth to be measured and the color of the shade guide match are compared to determine whether they match. This comparison is carried out for each measurement region defined as described above; it is performed by comparing the spectrum (in this embodiment, the spectral reflectance) of the measurement region and the spectrum (in this embodiment, the spectral reflectance) of each shade guide stored in advance in the shade-guide-reference-image data storage unit 82 to determine the shade guide having the minimum difference between the two spectra.

This is achieved, for example, by obtaining a spectrum-determining value (J value) based on equation (2) below.

$$Jvalue = C \sqrt{\frac{{\sum }_{λ} ( {( {f}_{1} ( λ ) - {f}_{2} ( λ ) )}^{2} {E ( λ )}^{2} )}{n}} \qquad ( 2 )$$

In equation (2), J value is the spectrum-determining value, C is a normalization coefficient, n is the sample number (number of wavelengths used in the calculation), k is wavelength, f1(λ) is the spectral responsivity curve (the spectral reflectance curve) of the tooth to be determined, f2(λ) is the spectral responsivity curve (the spectral reflectance curve) of the shade guide, and E(λ) is a determination responsivity correction curve. In this embodiment, weighting related to the spectral responsivity, which depends on the wavelength λ, is performed using E(λ).

Accordingly, the spectral curves of each shade guide are substituted for f2(λ) in equation (2) above to calculate the respective spectrum-determining values, J value. The shade guide exhibiting the smallest spectrum-determining value, J value, is determined to be the shade-guide number closest to the tooth. In this embodiment, a plurality of candidates (for example, three) are extracted in order of smallest spectrum-determining value, J value. Of course, it is also possible for the number of candidates to be extracted to be one. The determination responsivity correction curve E(λ) in equation (2) above may have various weights.

When the shade-guide number is selected in this way, the number is sent from the determination computing unit 81 to the image-display GUI unit 115. Chroma data corresponding to the selected shade-guide number is sent from a shade-guide chroma-data storage unit 114 to the image-display GUI unit 115.

On the other hand, in the observation-spectrum computing unit 72 of the chroma calculating unit 70, the spectrum of the object under the illumination light used for observation is obtained by multiplying the illumination light spectrum S(λ) used for observation by the spectrum of the tooth obtained in the spectrum-estimation computing unit 71. S(λ) is the spectrum of the light source used for observing the color of the tooth, such as a D65 or D55 light source, a fluorescent light source, or the like. This data is stored in advance in the image-filing functional unit 112. The spectrum of the object under the illumination light used for observation, which is obtained in the observation-spectrum computing unit 72, is sent to the chroma-value computing unit 73.

In the chroma-value computing unit 73, L*a*b* chromaticity values are calculated from the spectrum of the object under the illumination light used for observation, and predetermined areas are averaged and sent to the image-display GUI unit 115. These predetermined areas are defined, for example, at three positions at the top, middle, and bottom of the tooth.

On the other hand, a spectrum G(x,y,λ) of the object under the illumination light used for observation is sent to the color-image-generating processor 112, and RGB2(x,y), which is an RGB image for displaying on the monitor, is created and sent to the image-display GUI unit 115. This RGB image may be subjected to edge enhancement and so forth.

When the image-display GUI unit 115 receives the RGB image, the L*a*b* chromaticity values, the shade-guide number, and so on, which are obtained as described above, from the respective units, it displays an image on the display screen 4, as shown in FIG. 13.

As shown in FIG. 13, the image-display GUI unit 115 displays a color image A of the measurement object at the upper middle part of the display screen and displays an L*a*b* chromaticity distribution image B of the measured object to the right of the color image A. More specifically, the image-display GUI unit 115 displays a vertical scanning line Y, which can move up and down, and a horizontal scanning line X, which can move left and right, on the distribution image B, and at the intersection of these scanning lines Y and X, it displays a color difference distribution on the basis of the chroma at a specified reference position as the distribution image B.

In addition, the image-display GUI unit 115 displays the variation in color difference along the vertical scanning line Y or the horizontal scanning line X as a line graph C at the top right of the screen. Because the scanning lines Y and X displayed on the distribution image B are designed to be freely movable by the user, every time the scanning line Y or X is scanned, the GUI unit 115 obtains a color-difference distribution from the chroma calculating unit 70 on the basis of the reference position after scanning and quickly displays this information.

On the color image A, the image-display GUI unit 115 displays the plurality of measurement regions defined in the measurement-region defining processing performed in the determination computing unit 81 (see FIG. 4). Here, when any one region Q of the plurality of measurement regions is specified by the user, such as a doctor, a color image D of the shade guide selected as the one closest to the color of the specified measurement region Q is displayed at the bottom center of the screen, and its L*a*b* chromaticity distribution image E is displayed to the right of the color image D. A vertical scanning line Y and a horizontal scanning line X are also shown in this distribution image E, similarly to the distribution image B, and a color-difference distribution based on the chroma at a specified reference position is displayed at the intersection of these scanning lines Y and X. The image-display GUI unit 115 also displays the variation in color difference along the vertical scanning line Y or the horizontal scanning line X as a line graph F at the bottom right of the screen.

At the bottom left of the screen, the image-display GUI unit 115 displays, in the form of a list, information G about the selected shade guide corresponding to the measurement region Q described above. Here, the three shade-guide numbers selected by the shade-guide selecting processing performed in the determination computing unit 81 shown in FIG. 4 are displayed in decreasing order of spectrum-determining value (J value). The spectrum-determining value (J value) and the differences dE, dL*, da*, and db* between the chromaticity values of the tooth and the chromaticity values of the shade guide are displayed for each shade-guide number.

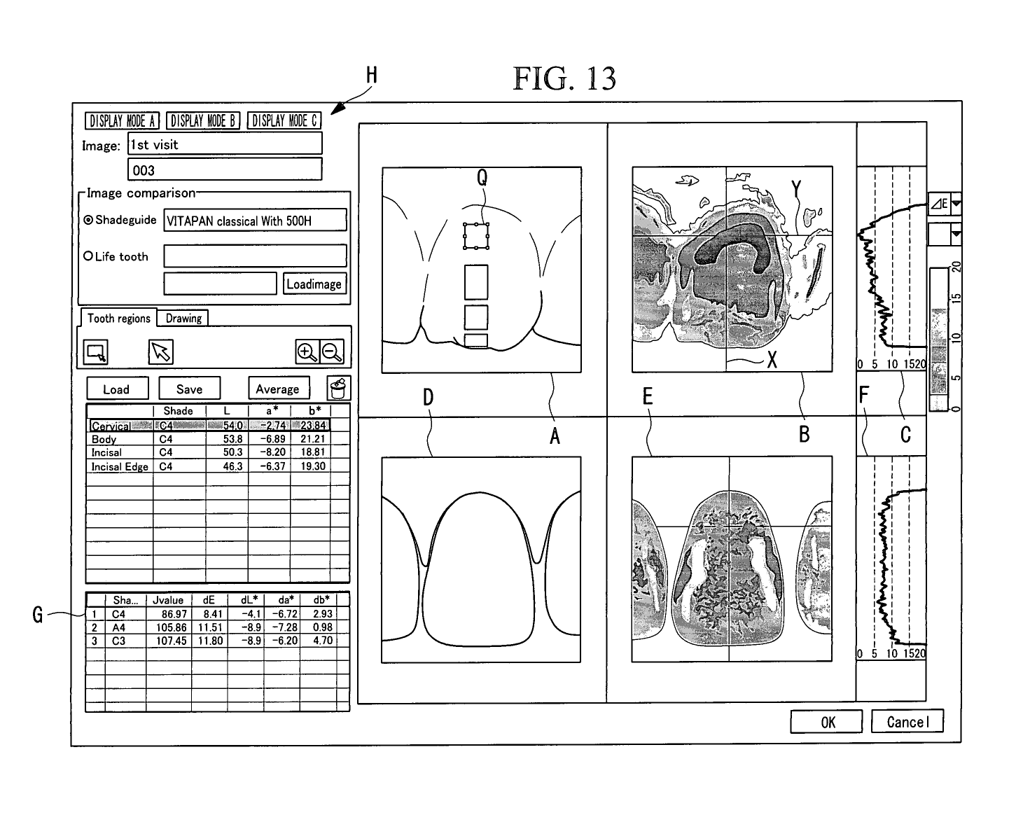

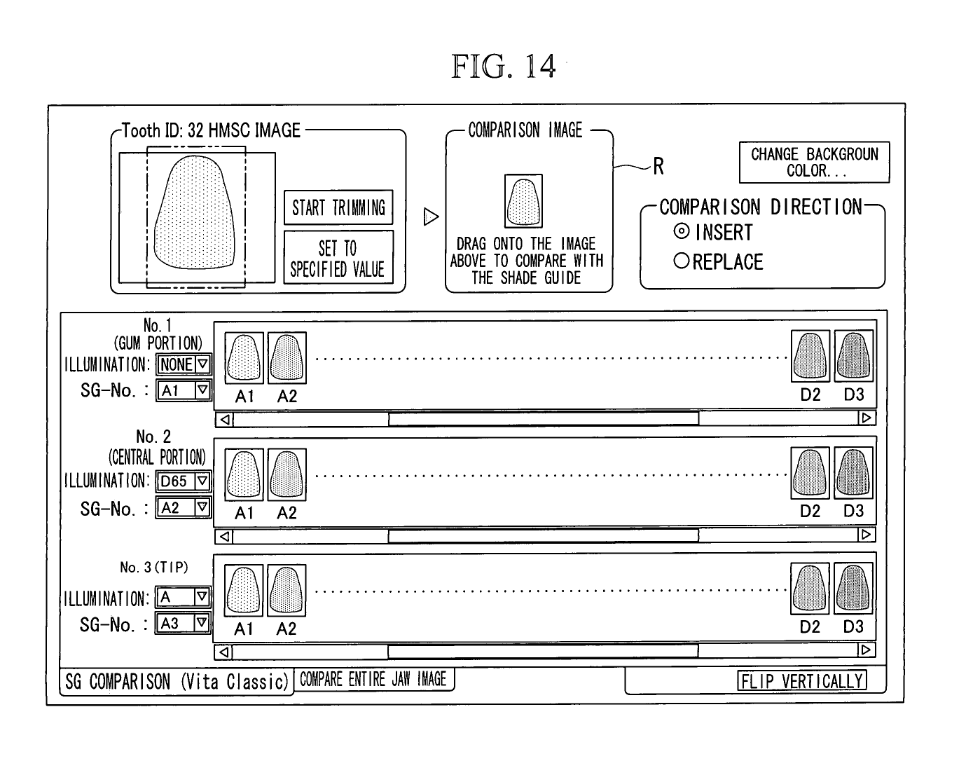

At the top left of the screen, the image-display GUI unit 115 displays mode-switching buttons H which allow the display mode to be changed. When these mode-switching buttons H are selected, the image-display GUI unit 115 changes the display screen to the screen shown in FIG. 14.

As shown in FIG. 14, the image-display GUI unit 115 displays a color image of the tooth being measured close to the top left of the screen. At the bottom center of the screen, the image-display GUI unit 115 displays a color image of the shade guides under predetermined illumination light and also displays the shade-guide numbers underneath.

In FIG. 14, “none”, “D65”, and “A” are selected as the illumination light sources. Here, “none” corresponds to a case where merely the spectral reflectance itself is displayed.

The system is designed such that the illumination light can be freely changed using pull-down menus. Accordingly, the user can easily select the desired illumination light and can check for color matching with the shade guide under the desired illumination light. The shade-guide number selected from the available shade guides in the shade-guide selecting processing performed in the shade-guide-number determining unit 80 shown in FIG. 4 is indicated by “SG-No” to the left of each shade-guide image.

At the top center of the screen, the image-display GUI unit 115 displays a comparison region R for displaying the tooth being measured and a predetermined shade guide adjacent to each other so as to facilitate comparison of the color of the tooth being measured and the color of the shade guide. When comparing a tooth and a shade guide, close comparison of the colors is difficult if they are displayed at separate location on the screen; the comparison region R is provided to eliminate such a problem.

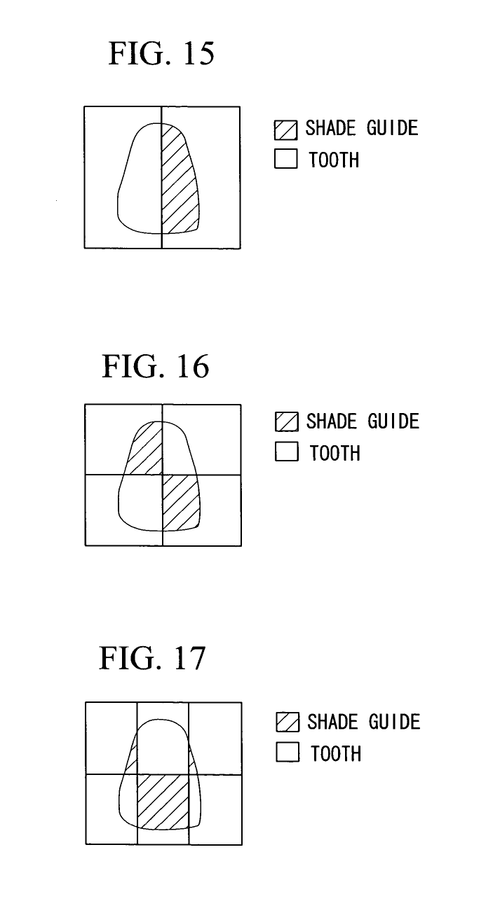

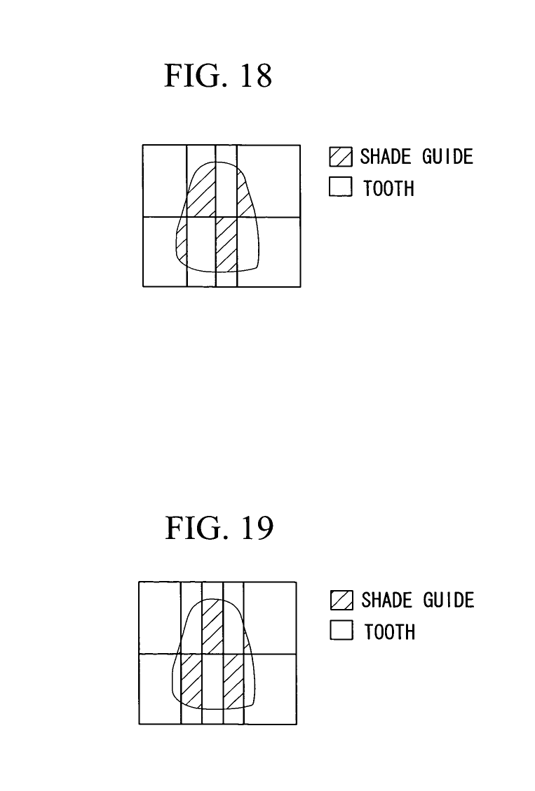

For example, when the shade guide to be compared is moved from among the shade guides displayed on the screen to the comparison region R by an input operation such as drag and drop, the image-display GUI unit 115 displays this shade guide and the object being measured adjacent to each other. The shade guide and the object being measured are divided into a desired number of divisions, and these divisions are displayed next to each other. For example, as shown in FIG. 15, if the number of divisions is “2”, the two halves are displayed next to each other, the left half of the tooth being shown at the left and the right half of the shade guide at the right. As shown in FIG. 16, if the number of divisions is “4”, the divisions are displayed next to each other by displaying the lower left portion and upper right portion of the tooth at the lower left and the upper right, respectively, and displaying the upper left portion and the lower right portion of the shade guide at the upper left and lower right, respectively. In a similar fashion, FIG. 17 shows a case where the number of divisions is “6”, FIG. 18 shows a case where the number of divisions is “8”, and FIG. 19 shows a case where the number of divisions is “10”. The number of divisions is not limited to these values; for example, odd numbers can also be used.

The number of shade guides that can be compared at once is not limited to one; the system may be designed such that a plurality of shade guides can be compared with a natural tooth at once, which allows a plurality shade guides and a natural tooth to be displayed next to each other. For example, in FIG. 16, among the four divided regions, one shade guide can be displayed at the top left, a shade guide that is different from the shade guide at the top left can be displayed at the bottom left, and the natural tooth can be displayed in the two regions at the right. Similarly, the system can also be designed such that a shade guide is compared with a plurality of natural teeth at once.

Accordingly, by displaying the tooth and shade guide side by side, it is possible to determine the degree of uniformity more visually and positively than direct comparison of the images, and the dentist can thus select a more suitable shade guide. In this embodiment, therefore, when the shade guide and the tooth being measured are displayed next to each other, as shown in FIGS. 15 to 19, it is easy to compare them because they are displayed side by side with no gap therebetween.

The boundary line between the tooth and the shade guide can be freely adjusted in position using a mouse or the like. Therefore, by moving the boundary line, it is possible to freely change the display ratio of the shade guide and the tooth.

### Second Embodiment

Next, a second embodiment of the present invention will be described with reference to the drawings.

In the dental colorimetry system according to this embodiment, the configuration of the shade-guide-number determining unit according to the first embodiment described above is different.

The dental colorimetry system according to this embodiment is described below with reference to the drawings.

Components that are identical to those in the first embodiment are assigned the same reference numerals, and a description thereof shall be omitted.

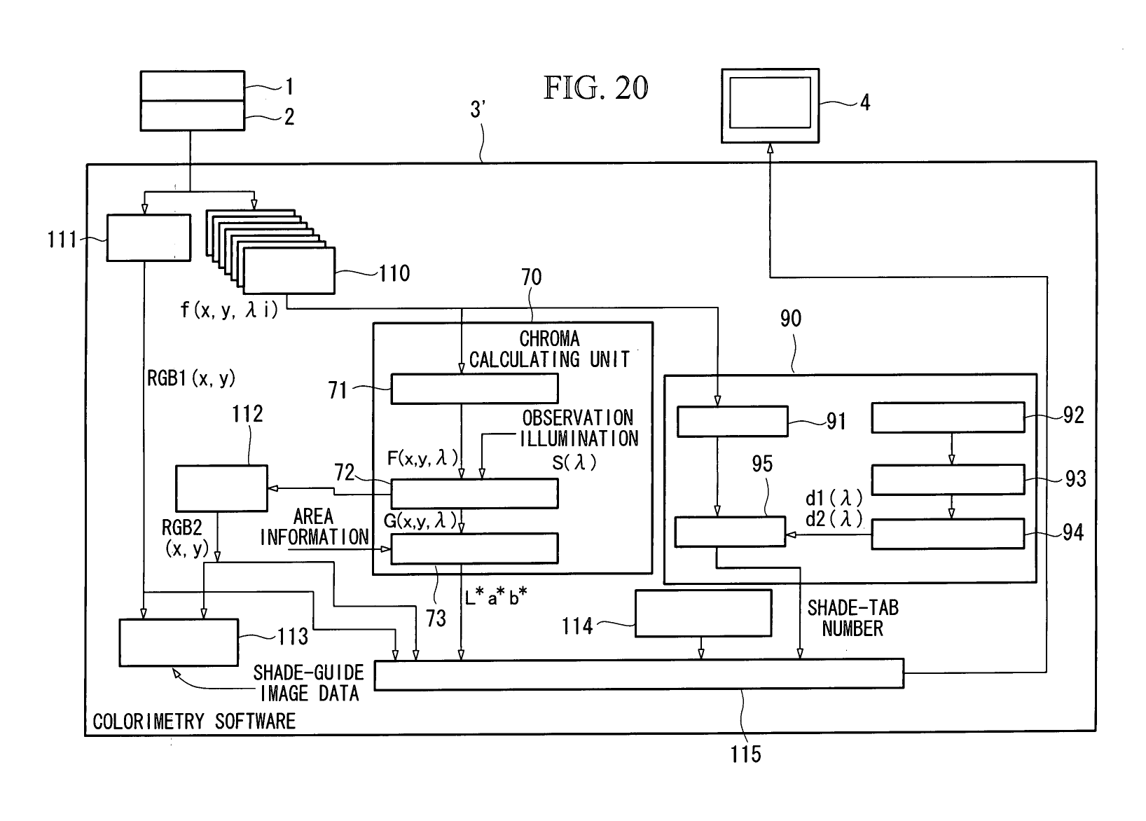

FIG. 20 is a block diagram showing the configuration of an image processing apparatus 3′ provided in the dental colorimetry system according to this embodiment.

A shade-guide-number determining unit 90 according to this embodiment is formed of a feature-value computing unit 91, a learning-data memory 92, a learning computing unit 93, a classification-spectrum memory 94, and a determination computing unit 95. The shade-guide-number determining unit 90 mainly performs determination calculations using two types of processing, known as learning processing and determination processing, to select a shade-guide number which is close to the color of the tooth being measured.

Learning Processing

Multispectral images formed by acquiring shade guides using respective image-acquisition apparatuses 1 are stored in the learning-data memory 92. At this time, it is possible to acquire a plurality of images of the same shade guide by changing the subject, the image-acquisition apparatus 1 used to acquire images, and so forth. In the case of Vita Classic, which is a typical shade guide, a single shade-guide group is formed of 16 individual shade guides (shade tabs). If each shade guide is acquired three times, a total of 48 color sample images are used as a learning image.

In the learning computing unit 93, a plurality of predetermined positions are cut out from the learning image described above, and are stored in the learning-data memory 92. This cutting out is performed, for example, in areas of 16 pixels×16 pixels, and each band is averaged in these areas and is converted to seven signal values. Therefore, in each cut out region, a combination of seven signal values (referred to as feature values) is possible. Each feature value is represented by a single point in seven-dimensional space.

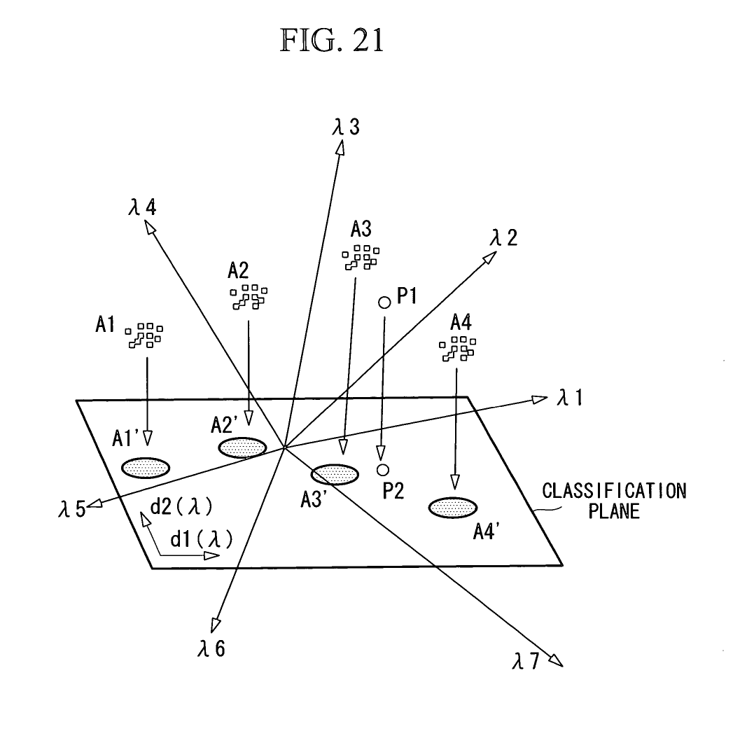

A schematic diagram is shown in FIG. 21. In FIG. 21, among the 16 available shade guides, four shade guides (A1, A2, A3, and A4) are plotted in seven-dimensional space. Point P1 is data for the tooth being measured. To select a shade guide close to the characteristic of this tooth data from all shade guides requires an enormous amount of computational processing. Thus, in this embodiment, a classification plane for optimally separating A1, A2, A3, and A4 is defined, as shown in FIG. 21. More specifically, classification spectra d1(λ) and d2(λ) for this plane projection are determined. Once the learning computing unit 93 determines the classification spectra d1(λ) and d2(λ) as described above, they are stored in the classification-spectrum memory 94.

In the description given above, the illumination light for determining the shade guide is the LED light from the image-acquisition unit 1; however, by using output data from the observation-spectrum computing unit 72 in the chroma calculating unit 70, it is possible to create learning data (the classification plane) under any type of illumination light.

Determination Processing

In the determination processing, a feature value is calculated in the feature-value computing unit 91 from the multispectral image data of the tooth being measured. This corresponds to the point P1 shown in FIG. 21.

Subsequently, the determination computing unit 95 selects the closest shade guide based on the feature value calculated in the feature-value computing unit 91 and the classification spectra d1(λ) and d2(λ) stored in the classification-spectrum memory 94. More specifically, the determination computing unit 95 projects the point P1 calculated in the feature-value computing unit 91 onto the classification plane to obtain a point P2. The coordinates of the point P2 can be obtained from the inner product of the classification spectra d1(λ) and d2(λ).

Then, the determination computing unit 95 calculates the distance between this point P2 and learning data A1′, A2′, A3′, and A4′, and the closest shade guide gives the corresponding shade-guide number.

The embodiments of the present invention have been described above with reference to the drawings. However, the actual configuration is not limited to these embodiments; various modifications are also included within the scope of the present invention so long as they do not depart from the spirit of the invention.

What is claimed is:

1. An image processing apparatus comprising:
a region specifying unit configured to specify a measurement-object region from an image;
a measurement-region defining unit configured to define at least one measurement region in the specified measurement-object region; and
a characteristic-sample selecting unit configured to respectively select, from a plurality of characteristic samples that are registered in advance, at least one characteristic sample which is close to a characteristic of each measurement region.

2. An image processing apparatus according to claim 1, wherein the region specifying unit specifies the measurement-object region based on a specific spectrum of the measurement object.

3. An image processing apparatus according to claim 1, wherein the characteristic-sample selecting unit calculates a difference between a spectrum of the measurement region and a spectrum of the characteristic sample and selects the characteristic sample based on the difference.

4. An image processing apparatus according to claim 1, wherein by applying spectral-responsivity-related weighting to a difference between a spectrum of the measurement region and a spectrum of the characteristic sample, the characteristic-sample selecting unit calculates a spectrum-determining value related to the degree of closeness of the two spectra and selects the characteristic sample based on the spectrum-determining value.

5. An image processing apparatus comprising:
a region specifying unit configured to specify a region of a tooth, serving as a measurement-object region, from an oral-cavity image;
a measurement-region defining unit configured to define at least one measurement region in the specified measurement-object region; and
a sample selecting unit configured to respectively select, from a plurality of tooth samples that are registered in advance, at least one tooth sample that is close to a spectrum of each measurement region.

6. An image processing apparatus according to claim 5, wherein the region specifying unit specifies the tooth region from the oral-cavity image based on a specific spectrum of the tooth.

7. An image processing apparatus according to claim 5, wherein the region specifying unit specifies the tooth region from the oral-cavity image based on a wavelength-band characteristic value, which is determined by a plurality of wavelength-band signals, and a specific spectrum of the tooth.

8. An image processing apparatus according to claim 5, wherein the sample selecting unit calculates differences between the spectrum of the measurement region and spectra of the tooth samples, and selects at least one tooth sample in order of decreasing difference.

9. An image processing apparatus according to claim 5, wherein by applying a spectral-responsivity-related weighting to a difference between the spectrum of the measurement region and a spectrum of the tooth sample, the sample selecting unit calculates a spectrum-determining value which is related to a degree of closeness of the two spectra and selects the tooth sample based on the spectrum-determining value.

10. An image processing method comprising:
a region specifying step of specifying a measurement-object region from an image;
a measurement-region defining step of defining at least one measurement region in the specified measurement-object region; and
a characteristic-sample selecting step of respectively selecting, from a plurality of characteristic samples that are registered in advance, at least one characteristic sample that is close to the characteristic of each measurement region.

11. An image processing program for causing a computer to execute:
region specifying processing for specifying a measurement-object region from an image;
measurement-region defining processing for defining at least one measurement region in the specified measurement-object region; and
characteristic-sample selecting processing for respectively selecting, from a plurality of characteristic samples that are registered in advance, at least one characteristic sample that is close to a characteristic of each measurement region.

12. An image processing system comprising:
an image-acquisition apparatus configured to acquire an image of an object including a measurement-object;
an image-processing apparatus configured to process the image acquired by the image-acquisition apparatus; and
a display device configured to display the image processed by the image processing apparatus,
wherein the image processing apparatus includes
a region specifying unit configured to specify the measurement-object region from the image acquired by the image-acquisition apparatus;
a measurement-region defining unit configured to define at least one measurement region in the specified measurement-object region; and
a characteristic-sample selecting unit configured to respectively select, from a plurality of characteristic samples that are registered in advance, at least one characteristic sample that is close to a characteristic of each measurement region.

13. A dental colorimetry system comprising:
an image-acquisition apparatus configured to acquire a oral-cavity image;
an image processing apparatus configured to process the image acquired by the image-acquisition apparatus; and
a display device configured to display the image processed by the image processing apparatus,
wherein the image processing apparatus includes
a region specifying unit for specifying a region of a tooth, serving as a measurement-object region, from the oral-cavity image acquired by the image-acquisition apparatus,
a measurement-region defining unit configured to define at least one measurement region in the specified measurement-object region, and
a sample selecting unit configured to respectively select, from a plurality of tooth samples that are registered in advance, at least one tooth sample that is close to a spectrum of each measurement region.

14. An image processing apparatus comprising:
a sample selecting unit configured to select, from tooth samples that are registered in advance, at least one tooth sample that is close to a spectrum of a measurement object; and
a display control unit configured to display a color image of the measurement object, a color image of the selected tooth sample, and identification information for specifying the tooth sample.

15. An image processing apparatus according to claim 14, wherein the display control unit displays color-difference information of the tooth sample with respect to the measurement object.

16. An image processing apparatus according to claim 14, wherein when a reference position is indicated on at least one of the color image of the measurement object and the color image of the tooth sample, the display control unit displays a chroma distribution image on the basis of a chroma value at the reference position.

17. An image processing apparatus according to claim 14, wherein the display control unit displays at least part of one or more color images of the measurement object and at least part of one or more color images of the tooth sample adjacent to each other.

18. An image processing apparatus according to claim 17, wherein a boundary between said at least part of the color image of the measurement object and said at least part of the color image of the tooth sample can move.

19. A display method comprising:
selecting, from tooth samples that are registered in advance, at least one tooth sample that is close to a spectrum of a measurement object; and
displaying a color image of the measurement object, a color image of the selected tooth sample, and identification information for specifying the tooth sample.

20. A display program for causing a computer to execute processing comprising:
selecting, from tooth samples that are registered in advance, at least one tooth sample that is close to a spectrum of a measurement object; and
displaying a color image of the measurement object, a color image of the selected tooth sample, and identification information for specifying the tooth sample.
